(19) United States
(12) Patent Application Publication
(10) Pub. No.: US 2017/0313806 A1
(43) Pub. Date: Nov. 2, 2017

(54) STABILIZATION OF FOAM POLYOL PREMIXES CONTAINING HALOGENATED OLEFIN BLOWING AGENTS

(71) Applicant: HONEYWELL INTERNATIONAL INC., MORRIS PLAINS, NJ (US)

(72) Inventors: BIN YU, TONAWANDA, NY (US); YIU KEUNG LING, AMHERST, NY (US); DAVID JOHN WILLIAMS, EAST AMHERST, NY (US)

(21) Appl. No.: 15/581,307

(22) Filed: Apr. 28, 2017

Related U.S. Application Data
(60) Provisional application No. 62/329,324, filed on Apr. 29, 2016.

(51) Int. Cl. C08G 18/34; C08G 18/18; C08G 18/40; C08G 18/08; C08G 18/66; C08G 18/76; C08J 9/14; C08J 9/00

(52) U.S. Cl. CPC C08G 18/348; C08G 18/7664; C08G 18/1808; C08G 18/4018; C08J 9/144; C08G 18/14; C08G 18/6692; C08G 18/6659; C08J 9/0061; C08J 2203/162; C08J 2375/08

(57) ABSTRACT

A storage stable polyol premix compositions, methods of forming such compositions, foamable compositions using the premix compositions, and methods of preparing foams containing the premix compositions, and foams made using the premix composition comprising a polyol component comprising at least 10 wt % of a cashew nutshell liquid based polyol based on a total weight of the polyol component, a tertiary amine catalyst, a silicone surfactant, and a blowing agent comprising a hydrohaloolefin are disclosed.

### CROSS REFERENCE TO RELATED APPLICATIONS

This application claims priority to U.S. Provisional application No. 62/329,324, filed Apr. 29, 2016.

The present invention pertains to polyurethane and polyisocyanurate foams and methods for the preparation thereof. More particularly, the invention relates to rigid, semi-rigid, and flexible polyurethane and polyisocyanurate foams and methods for their preparation, which foams are characterized by a fine uniform cell structure and little or no foam collapse. The foams are produced with an organic polyisocyanate and a polyol premix composition which comprises a combination of a blowing agent, a cashew nut shell liquid based polyol, a silicone surfactant, and a catalyst.

### BACKGROUND OF THE INVENTION

The class of foams known as low density, rigid, semi-rigid, and flexible polyurethane or polyisocyanurate foams has utility in a wide variety of insulation applications including roofing systems, building panels, building envelope insulation, refrigerators and freezers, seat cushions, mattresses, packaging materials, and the like.

For large-scale production of commercial rigid polyurethane foams, it is very important in many applications that such foams have the ability to provide a good balance of properties. It is desirable that rigid, closed cell polyurethane and polyisocyanurate foams are able to provide outstanding thermal insulation, excellent fire resistance properties, and superior structural properties at reasonably low densities. For semi-flexible and flexible polyurethane, it is desirably that the foams are known to provide superior cushioning and energy absorption properties.

The foam industry has historically used certain liquid, fluorocarbon blowing agents that were found to be easy to use under typical processing conditions. Those fluorocarbons not only acted as blowing agents by virtue of their volatility, but in the case of closed cell rigid foam, were also are encapsulated or entrained in the closed cell structure of the rigid foam and were the major contributor to the low thermal conductivity properties of the rigid urethane foams. The use of such fluorocarbons as the preferred commercial expansion or blowing agent in insulating foam applications was based in part on the k-factor associated with the foam produced. The k-factor is defined as the rate of transfer of heat energy by conduction through one square foot of one-inch thick homogenous material in one hour where there is a difference of one degree Fahrenheit perpendicularly across the two surfaces of the material. Since the utility of closed-cell polyurethane-type foams is based, in part, on their thermal insulation properties, applicants have come appreciate that it would be advantageous to identify materials that produce lower k-factor foams, preferably without substantially reducing the other important performance properties of the foam. In the case of flexible polyurethane foam, physical blowing agents, including those certain fluorocarbons, have been used to reduce the density of the foams to levels difficult to achieve using water alone.

It is known in the art to produce polyurethane and polyisocyanurate foams by reacting a polyisocyanate with a polyol in the presence of a blowing agent, a catalyst, a surfactant and optionally other ingredients. Heat generated when the polyisocyanate reacts with the polyol volatilizes the blowing agent contained in the liquid mixture, forming bubbles therein. As the polymerization reaction proceeds, the liquid mixture becomes a cellular solid, entrapping at least a portion of the blowing agent in the foam's cells in closed cell foams. If a surfactant is not used in the foaming composition, the bubbles tend to simply pass through the liquid mixture without forming a foam or forming a foam with large, irregular cells rendering it not useful for manyfoam applications.

Certain select compounds from within one or more of the following classes of materials have been used as suitable blowing agents: fluorocarbons, chlorocarbons, chlorofluorocarbons, hydrohaloolefins, hydrocarbons, ethers, esters, aldehydes, ketones, acetals, organic acids, atmospheric gases, materials that generate gas, for example CO₂, through decomposition or chemical reaction, such as, but not limited to, water, formic acid, and azodicarbonamide, and mixtures of two or more of these. Preferred blowing agents have low global warming potential. Among these blowing agents are hydrohaloolefins including hydrofluoroolefins (HFOs) (which include hydrochlorofluoroolefins (also known as HFCOs). Of particular interest are trans-1,3,3,3-tetrafluoropropene (HFO-1234ze(E)), cis-1,1,1,4,4,4-hexafluorobut-2-ene (HFO-1336mzz(Z)), and trans-1-chloro-3,3,3-trifluoropropene (HFO-1233zd(E)). Processes for the manufacture of 1,3,3,3-tetrafluoropropene are disclosed in U.S. Pat. Nos. 7,230,146 and 7,189,884. Processes for the manufacture of 1-chloro-3,3,3-trifluoropropene are disclosed in U.S. Pat. Nos. 6,844,475 and 6,403,847. As used herein, the designation “(E)” represents the trans isomer of the molecule and “(Z)” represents the cis isomer.

It is convenient in many applications to provide the components for polyurethane or polyisocyanurate foams in pre-blended formulations. Most typically, the foam formulation is pre-blended into two components. The polyisocyanate and optional isocyanate compatible raw materials comprise the first component, commonly referred to as the “A” component. A polyol or mixture of polyols, surfactant, catalyst, blowing agent, and other isocyanate reactive and non-reactive components comprise the second component, commonly referred to as the “B” component. Accordingly, polyurethane or polyisocyanurate foams are readily prepared by bringing together the A and B side components either by hand mix for small preparations and, preferably, machine mix techniques to form blocks, slabs, laminates, pour-in-place panels and other items, spray applied foams, froths, molded articles, and the like. Optionally, other ingredients such as flame retardants, colorants, auxiliary blowing agents, and other polyols can be added to the mixing head or reaction site. Most conveniently, however, they are all incorporated into one B component.

A shortcoming of two-component systems, especially those using certain hydrohaloolefins, including HFO-1234ze(E) and HFO-1233zd(E) is the shelf-life of the B-side composition. Normally when a foam is produced by bringing together the A and B side components, a good foam is obtained. However, if the polyol premix composition is aged prior to treatment with the polyisocyanate, the foams are of lower quality and may even collapse during the formation of the foam.

It has now been found that the origin of the problem is the reaction of certain amine catalysts with certain hydrohaloolefins including HFO-1234ze(E) and HFO-1233zd(E), resulting in partial decomposition of the blowing agent and consumption of the amine catalysts. It has been found that, subsequent to the decomposition of the blowing agent, the molecular weight of the polymeric silicone surfactants, if present, is detrimentally altered, leading to poor foam structure.

Various solutions to the problem have been developed including: separating the blowing agent, surfactant, and catalyst, for example by adding the blowing agent, or surfactant to the polyisocyanate, (“A” component); introducing the blowing agent, amine catalyst, or surfactant using a separate stream from the “A” or “B” component; blending the blowing agent or catalyst on site; and using the blend immediately after blending without extended storage. Other solutions include modifying the amine catalyst and using non-amine catalysts. Examples of modified amine catalysts are described in US 2009/0088272 and 2009/0099274, and examples of non-amine catalysts are described in US 2011/0152392. However, alternate catalysts and modified processes can be more expensive than traditional catalysts and processes.

Another proposed solution is the use of antioxidants. For example, US 2015/097614 illustrates the use of monohydroxy- and polyhydroxy-substituted aromatic compounds, such as catechol, as antioxidants which are blended with polyols to stabilize the polyol preblend containing HFOs, such as 1233zd(E). US 2015/097614 suggested that the amine catalysts reacted with 1233zd(E) and in turn formed an amine-halogenated hydroolefin radical. However, little evidence was provided for the existence of free radicals in the polyol preblend. US 2015/097614 also proposed that the antioxidants may provide at least some protection to the blowing agent even when a non-amine catalyst is used. However, it is generally understood that the amine catalyst reacts with 1233zd(E) blowing agent; non-amine catalysts are not believed to react with 1233zd(E) blowing agent. In addition, the chemicals used in US 2015/097614 will be oxidized to form o-quinones after acting as antioxidants; therefore, they do not have isocyanate-reactive hydroxyl groups on the substituted side chains of the monohydroxy- and polyhydroxy-substituted aromatic compounds and cannot be incorporated into the polyurethane chains. Furthermore, although these antioxidants proved to be useful for preventing the halogenated olefin from reacting with the catalyst, handling/processing of these materials can be extremely challenging. Catechol is a solid and needs to be dissolved in a solvent or in a polyol before it can be included in a polyol blend. More importantly, catechol is a toxic chemical, and its use in a polyol blend is undesirable; it would be very dangerous to the environment if it leaches out from a polyurethane foam.

It would be desirable to use existing amine catalysts and foam processes, and not to require reformulation of the catalyst component compositions or changing the foam process. Furthermore, it is desirable to use non-toxic materials in the catalyst component compositions.

Therefore, there is a need for a “B” component composition using existing amine catalysts and typical foam processes that produces good foam even if it has been aged prior to formation of the foam.

### SUMMARY OF THE INVENTION

The present invention relates generally to foam compositions, to storage stable polyol premix compositions, methods of forming such compositions, foamable compositions using the premix composition, methods of preparing foams using the premix composition, and foams made using the premix composition and/or foamable compositions. The preferred storage stable polyol premix compositions of the present invention utilize a cashew nutshell liquid based polyol, and such cashew nutshell liquid based polyol is preferably included in the foamable compositions of the present invention.

One aspect of the invention is a storage stable polyol premix composition. In one embodiment, the polyol premix composition includes a polyol component comprising at least 10 wt % of a cashew nutshell liquid based polyol based on a total weight of the polyol component, a tertiary amine catalyst, a surfactant, and a blowing agent comprising a hydrohaloolefin and optionally a fluorocarbon, chlorocarbon, chlorofluorocarbon, hydrocarbon, ether, ester, aldehyde, ketone, acetal, organic acid, atmospheric gas, water, gas generating materials, or combinations thereof.

Another aspect of the invention is a method of forming a storage stable polyol premix composition. In one embodiment, the method includes combining a polyol component comprising at least 10 wt % of a cashew nutshell liquid based polyol based on a total weight of the polyol component, a tertiary amine catalyst(s), a surfactant, and a blowing agent comprising a hydrohaloolefin, and optionally a fluorocarbon, chlorocarbon, chlorofluorocarbon, hydrocarbon, ether, ester, aldehyde, ketone, acetal, organic acid, atmospheric gases, water, gas generating materials, or combinations thereof.

Another aspect of the invention is a foamable composition. In one embodiment, the foamable composition comprises a mixture of an organic polyisocyanate and the polyol premix composition as described herein, and preferably a stored polyol premix composition as described herein.

Another aspect of the invention is a method of preparing a polyurethane or polyisocyanurate foam. In one embodiment, the method includes reacting an organic polyisocyanate with the polyol premix composition as described herein, and preferably a stored polyol premix composition as described herein.

Another aspect of the invention provides foam produced according to the methods as described herein.

### DESCRIPTION OF THE INVENTION

The invention provides a storage stable polyol premix composition which comprises a combination of blowing agent, cashew nutshell liquid based polyol and optionally other polyols, surfactant, and tertiary amine catalyst. By “storage stable polyol premix composition” we mean that the gel time of a foam formed from the polyol premix composition measured after aging at room temperature for 1 month is less than 50% greater than the gel time of a foam formed from the same polyol premix but without any substantial storage of the polyol premix after it is combined with the isocyante and/or polyurethane component. As used herein, the term “without any substantial storage” means that the polyol premix composition is used within about 12 hours of its formation. As used herein, “stored polyol premix” means a polyol premix which is not used for at least 12 hours after its formation. In preferred embodiments, the polyol premix compositions of the present invention have a storage stability value of less than 45%, or less than 40%, or less than 35%, or less than 30%, or less than 25%. As used herein, storage stability value designated by percentage refers to the relative percentage increase in the gel time of a foam formed from the polyol premix composition measured after the polyol is aged at room temperature for 1 month compared to the gel time of a foam formed from the same polyol premix but without any substantial storage of the polyol premix. For the purposes of convenience, the gel time of a foam formed from a polyol premix that is used without any substantial storage is referred to as “initial gel time” or “gel time measure initially.”

In some embodiments, the gel time of a foam formed from the polyol premix composition measured after aging at room temperature for 6 months is less than 100% greater than the gel time measured initially, or less than 95%, or less than 90%, or less than 85%, or less than 80%, or less than 75%, or less than 70%, or less than 65%, or less than 60%, or less than 55%, or less than 50%. In some embodiments, the gel time after aging for 1 month is less than 50% greater than the gel time measured initially, or less than 45%, or less than 40%, or less than 35%, or less than 30%, or less than 25%, and the gel time after aging for 6 months is less than 100% greater than the gel time measured initially, or less than 95%, or less than 90%, or less than 85%, or less than 80%, or less than 75%, or less than 70%, or less than 65%, or less than 60%, or less than 55%, or less than 50%. In some embodiments, the gel time after aging for 1 month is less than 35% greater than the gel time measured initially, and the gel time after aging for 6 months is less than 75% greater than the gel time measured initially, or less than 70%, or less than 65%, or less than 60%, or less than 55%, or less than 50%. In some embodiments, the gel time after aging for 1 month is less than 25% greater than the gel time measured initially, and the gel time after aging for 6 months is less than 65%, or less than 60%, or less than 55%, or less than 50%. In some embodiments, the gel time after aging for 1 month is less than 25% greater than the gel time measured initially, and the gel time after aging for 6 months is less than 50%.

The invention also provides a method of preparing a polyurethane or polyisocyanurate foam comprising reacting an organic polyisocyanate with a polyol premix composition according to the present invention, and preferably a stored polyol premix composition according to the present invention.

The polyol contained in the polyol premix compositions of the present invention comprises, consists essentially of, or consists of one or more cashew nutshell liquid based polyols. The cashew nutshell liquid based polyols can comprise cashew nutshell liquid based polyether polyols, cashew nutshell liquid based polyester polyols, and cashew nutshell liquid based Mannich polyols. Suitable cashew nutshell liquid based polyols include, but are not limited to, Polycard™ polyols available from Chemical Technical Services Inc. of Kettering Ohio (e.g., Polycard™ XFN-50, Polycard™ XFN-53, and Polycard™ 425M), Cardolite Corp. of Monmouth Junction N.J. (e.g., GX-9201, GX 9203, NX-9001, NX-9001LV, NX-9004, NX-5285, GX-9005, GX-9006, GX-9007, GX-9101, GX-9102, GX-9103, GX-9104), and BioBased Technologies of Rogers AR (such as Agrol Platinum).

In preferred embodiments, the cashew nutshell liquid based polyol is characterized as having a level of miscibility with the transHFCO-1233zd of at least about 30%, and more preferably at least about 40%, as measured at 70F in accordance with Example 1 hereof.

In preferred embodiments, the cashew nutshell liquid based polyol is characterized as having a level of miscibility with the transHFCO-1233zd of at least about 30%, and more preferably at least about 40%, as measured at 110F in accordance with Example 1 hereof.

In preferred embodiments, the cashew nutshell liquid based polyol comprises, consists essentially of, or consist of a natural aromatic oil consisting of a mixture of phenolic structures with a carboxyl group in ortho position and substituted in meta position with a hydrocarbon chain of 15 carbon atoms. In preferred embodiments the major component of cashew nutshell liquid based polyol is anacardic acid (90%). In preferred embodiments, the cashew nutshell liquid based polyol derived from a natural aromatic oil consisting of a mixture of phenolic structures with a carboxyl group in ortho position and substituted in meta position with a hydrocarbon chain of 15 carbon atoms by one or more processes, such as decarboxylation to caradanol, synthesis of Mannich bases, and/or alkoxyylation.

In preferred embodiments, the cashew nutshell liquid based polyol is characterized as an aromatic, multifunctional polyol, and amine polyol, and combinations of these. Cashew nutshell liquid based polyol sold under the trade designation POLYCARD ZFN is a family of products that are aromatic, multifunctional polyols, and amine polyols, and combinations of these.

In preferred embodiments, the cashew nutshell liquid based polyol is based on or formed in accordance with the teachings of U.S. Pat. No. 7,828,991, which is incorporated herein by reference.

In addition to the cashew nutshell liquid based polyol(s), the polyol premix compositions of the present invention can comprise one or more additional polyols. The additional polyol can be any polyol which reacts in a known fashion with an isocyanate in preparing a polyurethane or polyisocyanurate foam. Useful additional polyols comprise one or more of: a sucrose containing polyol; phenol; a phenol formaldehyde containing polyol; a glucose containing polyol; a sorbitol containing polyol; a methylglucoside containing polyol; toluene diamine; Mannich base; an aromatic polyester polyol; glycerol; ethylene glycol; diethylene glycol; propylene glycol; graft copolymers of polyether polyols with a vinyl polymer; a copolymer of a polyether polyol with a polyurea; one or more of (a) from the following list condensed with one or more of (b) from the following list:

(a) glycerine, ethylene glycol, diethylene glycol, trimethylolpropane, ethylene diamine, pentaerythritol, soy oil, lecithin, tall oil, palm oil, castor oil;

(b) ethylene oxide, propylene oxide, butylene oxide, a mixture of ethylene oxide and propylene oxide; or combinations thereof.

In preferred embodiments the polyol contained in the polyol premix compositions of the present invention consists essentially of, or consists of, one or more cashew nutshell liquid based polyols and/or one or more sucrose containing polyols or sucrose-based polyols.

In preferred embodiments the polyol contained in the polyol premix compositions of the present invention consists essentially of, or consists of, one or more cashew nutshell liquid based polyols and one or more sucrose containing polyols or sucrose-based polyols.

The polyol component (total amount of all cashew nutshell liquid based polyol(s) and optional additional polyol (if any)) is in preferred embodiments present in the polyol premix composition in an amount of from about 40 wt % to about 95 wt % by weight of the polyol premix composition, or from about 45 wt % to about 95 wt %, or from about 50 wt % to about 95 wt %, or from about 55 wt % to about 95 wt %, or from about 60 wt % to about 95 wt %, or from about 65 wt % to about 95 wt %, or from about 60 wt % to about 90 wt %.

When a mixture of cashew nutshell liquid based polyol(s) and an additional polyol is used, the cashew nutshell liquid based polyol (total amount of all cashew nutshell liquid based polyols) is preferably present in an amount of from about 5 wt. % to about 99 wt % by weight of the total polyol component (cashew nutshell liquid based polyol(s) and additional polyol), or from about 10 wt. % to about 99 wt %, or from about 15 wt.% to about 99 wt %, or from about 20 wt. % to about 99 wt %, or from about 25 wt. % to about 99 wt %, or from about 30 wt. % to about 99 wt %, or from about 35 wt. % to about 99 wt %, or from about 40 wt. % to about 99 wt %. The additional polyol is generally present in an amount of from about 1 wt. % to about 95 wt % by weight of total polyol, or from about 1 wt. % to about 90 wt %, or from about 1 wt. % to about 85 wt %, or from about 1 wt. % to about 80 wt %, or from about 1 wt. % to about 75 wt %, or from about 1 wt. % to about 70 wt %, or from about 1 wt. % to about 65 wt %, or from about 1 wt. % to about 60 wt %.

The amount and composition of the polyol component depends in part on the type of foam being made and the amount of catalyst being used. For foams utilizing higher levels of catalyst, for example spray foams, it is preferred to utilize a higher concentration of cashew nutshell liquid based polyol than those using lower levels of catalyst, for example, appliance foams, panel foams, and flexible foams. Flexible foams preferably are formed in certain embodiments from polyol premix compositions containing from about 80 wt % to about 95 wt % polyol component by weight of the polyol premix. The polyol component in polyol premix compositions for use in making flexible foam, which frequently uses the least amount of catalyst compared to other foam types, in preferred embodiments includes from about 10 wt % to about 99 wt % cashew nutshell liquid based polyol(s) and from about 1 wt % to about 90 wt % additional polyol by weight of the polyol component. For polyol premix compositions for use in making spray foam, it is preferred that the polyol premix composition comprises from about 65 wt % to about 85 wt % polyol component by weight of the polyol premix. The polyol component in polyol premix compositions for use in making spray foam, which frequently uses the highest amount of catalyst, in preferred embodiments includes from about 30 wt % to about 99 wt % cashew nutshell liquid based polyol(s) and from about 1 wt % to about 70 wt % additional polyol by weight of total polyols. For appliance foam, preferred embodiments include from about 65 wt % to about 85 wt % polyol component by weight of the polyol premix. The polyol component in polyol premix compositions for use in making appliance foam in preferred embodiments includes from about 20 wt % to about 99 wt % cashew nutshell liquid based polyol(s) and from about 1 wt % to about 80 wt % additional polyol by weight of the polyol component. For polyurethane (PUR) panel foam, preferred embodiments include from about 65 wt % to about 80 wt % polyol component by weight of the polyol premix. The polyol component in polyol premix compositions for use in making PUR panel foam in preferred embodiments contains from about 20 wt % to about 99 wt % cashew nutshell liquid based polyol(s) and from about 1 wt % to about 80 wt % additional polyol by weight of the polyol component. For polyisocyanurate (PIR) panel foam, preferred embodiments include from about 65 wt % to about 85 wt % polyol component by weight of the polyol premix. For polyol premix compositions for use in makingPlR panel foam, the polyol component of the premix composition preferably comprises from about 20 wt % to about 99 wt % cashew nutshell liquid based polyol(s) and from about 1 wt % to about 80 wt % additional polyol by weight of the polyol component.

The blowing agent comprises a hydrohaloolefin, and optionally a fluorocarbon, chlorocarbon, chlorofluorocarbon, hydrocarbon, ether, ester, aldehyde, ketone, acetal, organic acid, atmospheric gas, water, gas generating materials, or combinations thereof. By gas generating material, we mean a material that generates gas, for example CO₂, through decomposition or chemical reaction. Examples of gas generating materials include, but are not limited to, water, formic acid, or azodicarbonamide The hydrohaloolefin preferably comprises at least one of trans-HFO-1234ze(E), trans-HFO-1233zd(E), and cis-HFO-1336mzz(Z).

The hydrohaloolefin preferably comprises at least one haloalkene such as a fluoroalkene or chloroalkene containing from 3 to 4 carbon atoms and at least one carbon-carbon double bond. Preferred hydrohaloolefins non-exclusively include: trifluoropropenes; tetrafluoropropenes, such as trans-HFO-1234ze or cis-HFO-1234ze; pentafluoropropenes such as HFO-1225; hexafluorobutenes, such as cis-HFO-1336mzz or trans-HFO-1336mzz chlorotrifluoropropenes such as trans-HFO-1233zd, cis-HFO-1233zd, HFO-1233xf; chlorodifluoropropenes; chlorotetrafluoropropenes, and combinations of these. More preferred are the tetrafluoropropene, pentafluoropropene, and chlorotrifluoropropene compounds in which the unsaturated terminal carbon has not more than one F or Cl substituent. Included are trans-1,3,3,3-tetrafluoropropene (HFO-1234ze); 2,3,3,3-tetrafluoropropene (HFO-1234yf); 1,1,3,3-tetrafluoropropene; cis-1,2,3,3,3-pentafluoropropene (HFO-1225ye); trans-1,2,3,3,3-pentafluoropropene (HFO-1225ye); 1,1,1-trifluoropropene; 1,1,1,3,3-pentafluoropropene (HFO-1225zc); 1,1,1,3,3,3-hexafluorobut-2-ene, 1,1,2,3,3-pentafluoropropene (HFO-1225yc); cis-1,1,1,2,3-pentafluoropropene (HFO-1225ye); trans-1-chloro-3,3,3-trifluoropropene (HFO-1233zd); 2-chloro-3,3,3-trifluoropropene (HFO-1233xf); trans-1,1,1,4,4,4-hexafluorobut-2-ene (HFO-1336mzz), cis-1,1,1,4,4,4,-hexafluoro-2-butene (HFO-1336mzz) or combinations thereof, and any and all structural isomers, geometric isomers, or stereoisomers of each of these.

Preferred hydrohaloolefins have a Global Warming Potential (GWP) of not greater than 150, more preferably not greater than 100 and even more preferably not greater than 75. As used herein, “GWP” is measured relative to that of carbon dioxide and over a 100-year time horizon, as defined in “The Scientific Assessment of Ozone Depletion, 2002, a report of the World Meteorological Associations Global Ozone Research and Monitoring Project,” which is incorporated herein by reference. Preferred hydrohaloolefins also preferably have an Ozone Depletion Potential (ODP) of not greater than 0.05, more preferably not greater than 0.02 and even more preferably about zero. As used herein, “ODP” is as defined in “The Scientific Assessment of Ozone Depletion, 2002, A report of the World Meteorological Associations Global Ozone Research and Monitoring Project,” which is incorporated herein by reference.

Preferred optional blowing agents include CFC-11 (CCl₃F), CFC-12 (CCl₂F₂), HCFC-141b (CH₃CCl₂F), HCFC-142b (CH₃CClF₂), HCFC-22 (CHClF₂), HFC-245fa (CHF₂CH₂CF₃), HFC-365mfc (CH₃CF₂CH₂CF₃), HFC-227ea (CF₃CHFCF₃), HFC-134a (CH₂FCF₃), HFC-152a (CH₃CHF₂), trans-1,2-dichloroethylene, propane, butane, isobutane, normal pentane, isopentane, cyclopentane, dimethyl ether, methyl formate, methyl acetate, acetone, methylal, ethylal, carbon dioxide, water, formic acid, acetic acid, polymeric acids, and mixtures or two or more of these.

Most preferred optional blowing agents include HFC-245fa (CHF₂CH₂CF₃), HFC-365mfc (CH₃CF₂CH₂CF₃), HFC-227ea (CF₃CHFCF₃), HFC-134a (CH₂FCF₃), HFC-152a (CH₃CHF₂), trans-1,2-dichloroethylene, butane, isobutane, normal pentane, isopentane, cyclopentane, dimethyl ether, methyl formate, acetone, methylal, carbon dioxide, water, formic acid and mixtures or two or more of these. Water reacts with the isocyanate to form carbon dioxide. Formic acid reacts with isocyanate to form carbon dioxide and carbon monoxide.

In preferred embodiments, the blowing agent component is present in the polyol premix composition in an amount of from about 0.5 wt % to about 40 wt %, or from about 1 wt % to about 40 wt %, or from about 2 wt % to about 40 wt %, or from about 0.5 wt % to about 30 wt %, or from about 1 wt % to about 30 wt %, or from about 2 wt % to about 30 wt %, or from about 0.5 wt % to about 25 wt %, or from about 1 wt % to about 25 wt %, or from about 2 wt % to about 25 wt % by weight of the polyol premix composition.

The amount of blowing agent can vary widely depending on many factors, including the type of foam being made. In preferred embodiments, polyol premixes of the present invention for use in making flexible foam contain a relatively low amount of blowing agent, for example preferably from about 0.5 wt % to about 10 wt %, or from about 0.5 wt % to about 8 wt %, or from about 0.5 wt % to about 6 wt %, or from about 0.5 wt % to about 5 wt %, or from about 0.5 wt % to about 4 wt %. In preferred embodiments, polyol premixes of the present invention for use in making spray foam contain from about 4 wt % to about 15 wt % blowing agent, or from about 6 wt % to about 12 wt %. In preferred embodiments, polyol premixes of the present invention for use in making appliance foam, PIR foam, and PUR foam contain from about 5 wt % to about 30 wt % blowing agent, or from about 10 wt % to about 30 wt %, or from about 15 wt % to about 30 wt %.

When both a hydrohaloolefin and an optional blowing agent are present, the hydrohaloolefin component is usually present in the blowing agent component in an amount of 1 wt % to 99 wt % by weight of the blowing agent component, or 5 wt % to 99 wt %, or 10 wt % to 99 wt %, or 15 wt % to 99 wt %, or 20 wt % to 99 wt %, or 25 wt % to 99 wt %, or 30 wt % to 99 wt %, or 35 wt % to 99 wt %, or 40 wt % to 99 wt %, or 40 wt % to 99 wt %, or 45 wt % to 99 wt %, or 50 wt % to 99 wt %, or 55 wt % to 99 wt %, or 60 wt % to 99 wt %, or 65 wt % to 99 wt %, or 70 wt % to 99 wt %, or 75 wt % to 99 wt %, or 80 wt % to 99 wt %, or 85 wt % to 99 wt %, or 90 wt % to 99 wt %; and the optional blowing agent is usually present in the blowing agent component in an amount of 99 wt % to 1 wt % by weight of the blowing agent component, or 95 wt % to 1 wt %, or 90 wt % to 1 wt %, or 85 wt % to 1 wt %, or 80 wt % to 1 wt %, or 75 wt % to 1 wt %, or 70 wt % to 1 wt %, or 65 wt % to 1 wt %, or 60 wt % to 1 wt %, or 55 wt % to 1 wt %, or 50 wt % to 1 wt %, or 45 wt % to 1 wt %, or 40 wt % to 1 wt %, or 35 wt % to 1 wt %, or 30 wt % to 1 wt %, or 25 wt % to 1 wt %, or 20 wt % to 1 wt %, or 15 wt % to 1 wt %, or 10 wt % to 1 wt %.

The composition of the blend of blowing agents can vary widely, depending on several factors, including the type of foam being made. In preferred embodiments, polyol premixes of the present invention for use in making flexible foams include from about 40 wt % to about 60 wt % hydrohaloolefin and from about 60 wt % to about 40 wt % optional blowing agent. In preferred embodiments, polyol premixes of the present invention for use in making spray foam include from about 50 wt % to about 85 wt % hydrohaloolefin and from about 50 wt % to 15 wt % optional blowing agent, or from about 60 wt % to about 85 wt % hydrohaloolefin and from about 40 wt % to about 15 wt % optional blowing agent. In preferred embodiments, polyol premixes of the present invention for use in making appliance foams, PIR panel foams, and PUR panel foams include from about 90 wt % to about 99 wt % hydrohaloolefin and from about 10 wt % to about 1 wt % optional blowing agent.

The polyol premix composition of the present invention also preferably contains a surfactant. The surfactant can be a silicone surfactant. The silicone surfactant is used to form a foam from the mixture, as well as to control the size of the bubbles of the foam so that a foam of a desired cell structure is obtained. Preferably, a foam with small bubbles or cells therein of uniform size is desired since it has the most desirable physical properties such as compressive strength and thermal conductivity. Also, the foam should have stable cells which do not collapse prior to forming or during foam rise.

Silicone surfactants for use in the preparation of polyurethane or polyisocyanurate foams are available under a number of trade names known to those skilled in this art. Such materials have been found to be applicable over a wide range of formulations allowing uniform cell formation and maximum gas entrapment to achieve very low density foam structures. The preferred silicone surfactant comprises a polysiloxane polyoxyalkylene block co-polymer. Some representative silicone surfactants useful for this invention are Momentive's L-6642, L-6620, L-6891, L-6972,L-5345, L-6705, L-6124,Y10762, L-5130, L-5180, L-5340, L-5440, L-6100, L-6900, L-6980 and L-6988; Air Products DC-193, DC-197, DC-SI 3102, DC-513504, DC2525, DC-2585, DC-5043, DC-5582, and DC-5598; and B-8404, B-8407, B-8409 and B-8462 from Goldschmidt AG of Essen, Germany, and Silstab 2450 from Siltech, Canada. Others are disclosed in U.S. Pat. Nos. 2,834,748; 2,917,480; 2,846,458 and 4,147,847.

The silicone surfactant component is usually present in the polyol premix composition in an amount of of from about 0.1 wt % to about 10 wt %, or from about 0.2 wt % to about 5 wt %, or from about 0.2 wt % to about 3.0 wt %, by weight of the polyol premix composition.

The polyol premix composition may optionally contain a non-silicone surfactant. These may include oxyethylated alkylphenols, oxyethylated fatty alcohols, paraffin oils, castor oil esters, ricinoleic acid esters, turkey red oil, groundnut oil, paraffins and fatty alcohols. Preferred non-silicone non-ionic surfactants are LK-443 and LK 221 which are commercially available from Air Products Corporation, and Vorasurf-504 available from Dow.

When a non-silicone surfactant used, it is usually present in the polyol premix composition in an amount of from about 0.1 wt % to about 10 wt %, or from about 0.2 wt % to about 5 wt %, or from about 0.2 wt % to about 3.0 wt %, by weight of the polyol premix composition.

The polyol premix composition contains an amine catalyst. In one embodiment, the amine has the formula R₁R₂N[A-NR₃]—R₄ wherein each of R₁, R₂, R₃,and R₄ is independently H, a C₁ to C₈ alkyl group, a C₁ to C₈ alkenyl group, C C₁ to C₈ alcohol group, or a C₁ to C₈ ether group, or R₁ and R₂ together form a C₅ to C₇ cyclic alkyl group, a C₅ to C₇ cyclic alkenyl group, a C₅ to C₇ heterocyclic alkyl group, or a C₅ to C₇ heterocyclic alkenyl group; A is a C₁ to C₅ alkyl group, a C₁ to C₅ alkenyl group, or an ether; n is 0, 1, 2, or 3.

Useful tertiary amine catalysts include, but are not limited to, N,N-dimethylcyclohexylamine, N,N-dimethylethanolamine, dimethylaminoethoxyethanol, N,N,N′-trimethylaminoethyl-ethanolamine, N,N,N′-trimethyl-N′-hydroxyethylbisaminoethylether, tetramethyliminobispropylamine, 2-[[2-[2-(dimethylamino)ethoxy]ethyl]methylamino] ethanol, pentamethyldiethylene-triamine, pentamethyldipropylenetriamine, N,N,N′,N″,N″-pentamethyl-dipropylenetriamine, 1,1,4,7,10,10-hexamethyltriethylenetetramine, N,N-bis(3-dimethylaminopropyl)-N-isopropanolamine, N′-(3-(dimethylamino)propyl)-N,N-dimethyl-1,3-propanediamine, bis(3-dimethylaminopropyl)-n, n-dimethylpropanediamine, bis-(2-dimethylaminoethyl)ether, N,N′,N″-dimethylaminopropylhexahydrotriazine, tetramethyliminobispropylamine, trimethyl-n′,2-hydroxyethyl-propylenediamine, Bis-(3-aminopropyl)-methylamine, N,N-dimethyl-1,3-propanediamine, 1-(dimethylamino)hexadecane, benzyldimethylamine, 3-dimethylaminopropyl urea, dicyclohexylmethylamine; ethyldiisopropylamine; dimethylisopropylamine; methylisopropylbenzylamine; methylcyclopentylbenzylamine; isopropyl-sec-butyl-trifluoroethylamine; diethyl-(α-phenylethyl)amine, tri-n-propylamine, or combinations thereof.

Other useful amines include, but are not limited to, morpholines, imidazoles, ether containing compounds, and the like. These include dimorpholinodiethylether, N-ethylmorpholine, N-methylmorpholine, 4-hexadecylmorpholine, dimethyl-4-morpholineethanamine, bis(dimethylaminoethyl) ether, imidazole, n-methylimidazole, 1,2-dimethylimidazole.

The amine catalyst is usually present in the polyol premix composition in an amount of from about 0.2 wt % to about 8.0 wt %, or from about 0.4 wt % to about 7.0 wt %, or from about 0.5 wt % to about 6.0 wt %, by weight of the polyol premix composition.

The polyol premix composition may optionally further comprise a non-amine catalyst. Suitable non-amine catalysts may comprise an organometallic compound containing bismuth, lead, tin, cobalt, aluminum, mercury, zinc, nickel, copper, manganese, zirconium, sodium, potassium, or combinations thereof. These non-exclusively include bismuth nitrate, bismuth salts of carboxylic acids (e.g., bismuth-2-ethylhexonate), lead 2-ethylhexoate, lead benzoate, antimony glycolate, stannous salts of carboxylic acids, zinc salts of carboxylic acids, dialkyl tin salts of carboxylic acids (e.g., dibutyltin dilaurate, dimethyltin dineodecanoate, dioctyltin dineodecanoate, dibutyltin dilaurylmercaptide dibutyltin diisooctylmaleate dimethyltin dilaurylmercaptide dioctyltin dilaurylmercaptide, dibutyltin dithioglycolate, dioctyltin dithioglycolate), potassium acetate, potassium octoate, potassium 2-ethylhexoate, glycine salts, quaternary ammonium carboxylates, alkali metal carboxylic acid salts, and N-(2-hydroxy-5-nonylphenol)methyl-N-methylglycinate, tin (II) 2-ethylhexanoate, or combinations thereof. Suitable commercially available metal catalysts include Dabco MB20 by Air Products, K-Kat XC C227, K-Kat XK614, K-Kat XK628, K-Kat XK651 by King Industries, Bicat 8210, Bicat 8106, Bicat 8, Bicat 8842, Bicat 8840 by Shepherd, Pucat 25 by Nihon Kagaku Sangyo, U600H by Nitto Kasei, and Tromax Bismuth 24 by Troy Chemical.

When the optional non-amine catalyst is used, it is usually present in the polyol premix composition in an amount of from about 0.01 wt % to about 2.5 wt %, or from about 0.05 wt % to about 2.25 wt %, or from about 0.10 wt % to about 2.00 wt % of the polyol premix composition. While these are usual amounts, the quantity amount of metallic catalyst can vary widely, and the appropriate amount can be easily be determined by those skilled in the art.

Conventional flame retardants can optionally be incorporated, preferably in an amount of not more than about 20 wt % of the polyol premix, or not more than about 15 wt %, or not more than about 10 wt %. Some embodiments, such as appliance foam, typically do not contain any flame retardant. Optional flame retardants include tris(2-chloroethyl)phosphate, tris(2-chloropropyl)phosphate, tris(2,3-dibromopropyl)phosphate, tris(1,3-dichloropropyl)phosphate, tri(2-chloroisopropyl)phosphate, tricresyl phosphate, tri(2,2-dichloroisopropyl)phosphate, diethyl N,N-bis(2-hydroxyethyl) aminomethylphosphonate, dimethyl methylphosphonate, tri(2,3-dibromopropyl)phosphate, tri(1,3-dichloropropyl)phosphate, and tetra-kis-(2-chloroethyl)ethylene diphosphate, triethylphosphate, diammonium phosphate, various halogenated aromatic compounds, antimony oxide, aluminum trihydrate, polyvinyl chloride, melamine, and the like.

In addition to the previously described ingredients, other ingredients such as, dyes, fillers, pigments, dispersing agents, cell stabilizers, nucleating agents (such as 3M's perfluoro compounds, PF-5056 and FA-188), nanoclays, and the like can be included in the preparation of the foams. The other ingredients will typically be included in an amount up to a total of 20 wt % of the polyol premix composition, or not more than 15 wt %, or not more than 10 wt %, or not more than 5 wt %. Conventional fillers for use herein include, for example, aluminum silicate, calcium silicate, magnesium silicate, calcium carbonate, barium sulfate, calcium sulfate, glass fibers, carbon black and silica. A pigment which can be used herein can be any conventional pigment such as titanium dioxide, zinc oxide, iron oxide, antimony oxide, chrome green, chrome yellow, iron blue siennas, molybdate oranges and organic pigments such as para reds, benzidine yellow, toluidine red, toners and phthalocyanines.

The polyol premix compositions of the present invention preferably contain from about 60 wt % to about 90 wt % of the polyol component (cashew nutshell liquid based polyol and additional polyol). In preferred embodiments the polyol premix composition contains a polyol component that comprises from about 10 wt % to about 99 wt % (based on total weight of polyol component) of a polyether cashew nutshell liquid based polyol, and from about 1 wt % to about 90 wt % (based on total weight of polyol component) of an additional polyol, such as polyester polyols, polyether polyols, and Mannich polyols. In preferred embodiments the polyol premix composition contains from about 2 wt % to about 30 wt % of a blowing agent (based on total polyol premix). The blowing agent can be a mixture of a hydrohaloolefin, such as trans-HFO-1234ze(E), trans-HFO-1233zd(E), and cis-HFO-1336mzz(Z), and a second blowing agent, such as water. The hydrohaloolefin can be present in an amount of from about 40 wt % to about 99 wt %, by weight of the blowing agent component, and the second blowing agent can be present in an amount of from about 1 wt % to about 60 wt %, by weight of the blowing agent component. There can be 0.2 to 3 wt % of a silicone surfactant, such as a polysiloxane polyoxyalkylene block co-polymer. The polyol premix can contain 0.75 wt % to 2.0 wt % of a non-silicone surfactant. The polyol premix composition can contain 0.7 wt % to 6.0 wt % of a tertiary amine catalyst. The polyol premix may contain 0.10 wt % to 2.00 wt % of a non-amine catalyst. The polyol premix may contain up to 20 wt % of flame retardant, and up to 20 wt % of other additives.

A typical formulation for foam used for appliances, PIR panels, and PUR panels would be 65 wt % to 80 wt % of polyol based on total polyol premix (20 wt % to 99 wt % cashew nutshell liquid based polyol and 1 wt % to 80 wt % additional polyol (based on total weight of polyol)). The polyol premix composition may contain 20 wt % to 30 wt % of a blowing agent (based on total polyol premix) (92 wt % to 97 wt % of trans-HFO-1234ze(E), trans-HFO-1233zd(E), cis-HFO-1336mzz(Z), or combinations thereof and 3 wt % to 8 wt % water). There can be 0.2 to 3 wt % of a silicone surfactant, optionally 0.75 wt % to 2.0 wt % of a non-silicone surfactant, 0.7 wt % to 4 wt % of a tertiary amine catalyst, 0.10 wt % to 2.00 wt % of a non-amine catalyst. The polyol premix may contain optionally 15 wt % of flame retardant, and 10 wt % of other additives.

A typical formulation for spray foam application would be 65 wt % to 80 wt % of polyol based on total polyol premix (40 wt % to 99 wt % cashew nutshell liquid based polyol and 1 wt % to 60 wt % additional polyol (based on total weight of polyol)). The polyol premix composition may contain 6 wt % to 12 wt % of a blowing agent (based on total polyol premix) (60 wt % to 85 wt % of trans-HFO-1234ze(E), trans-HFO-1233zd(E), cis-HFO-1336mzz(Z), or combinations thereof and 15 wt % to 40 wt % water). There can be 0.2 to 3 wt % of a silicone surfactant, optionally 0.75 wt % to 2.0 wt % of a non-silicone surfactant, 0.7 wt % to 6.0 wt % of a tertiary amine catalyst, 0.10 wt % to 2.00 wt % of a non-amine catalyst. The polyol premix may contain 15 wt % of flame retardant, and 10 wt % of other additives.

A typical flexible foam formulation would be 80 wt % to 95 wt % of polyol based on total polyol premix (10 wt % to 99 wt % cashew nutshell liquid based polyol and 1 wt % to 90 wt % additional polyol (based on total weight of polyol)). The polyol premix composition may contain 0.5 wt % to 4 wt % of a blowing agent (based on total polyol premix) (40 wt % to 50 wt % of trans-HFO-1234ze(E), trans-HFO-1233zd(E), cis-HFO-1336mzz(Z), or combinations thereof and 50 wt % to 60 wt % water). There can be 0.2 to 3 wt % of a silicone surfactant, 0.75 wt % to 2.0 wt % of a non-silicone surfactant, 0.7 wt % to 3 wt % of a tertiary amine catalyst, 0.10 wt % to 0.5wt % of a non-amine catalyst. The polyol premix may contain 10 wt % of flame retardant, and 10 wt % of other additives.

The preparation of polyurethane or polyisocyanurate foams using the compositions described herein may follow any of the methods well known in the art can be employed, see Saunders and Frisch, Volumes I and II Polyurethanes Chemistry and technology, 1962, John Wiley and Sons, New York, N.Y. or Gum, Reese, Ulrich, Reaction Polymers, 1992, Oxford University Press, New York, N.Y. or Klempner and Sendijarevic, Polymeric Foams and Foam Technology, 2004, Hanser Gardner Publications, Cincinnati, Ohio. In general, polyurethane or polyisocyanurate foams are prepared by combining an isocyanate, the polyol premix composition, and other materials such as optional flame retardants, colorants, or other additives. These foams can be rigid, flexible, or semi-rigid, and can have a closed cell structure, an open cell structure or a mixture of open and closed cells.

It is convenient in many applications to provide the components for polyurethane or polyisocyanurate foams in pre-blended formulations. Most typically, the foam formulation is pre-blended into two components. The isocyanate and optionally other isocyanate compatible raw materials comprise the first component, commonly referred to as the “A” component. The polyol mixture composition, including surfactant, catalysts, blowing agents, and optional other ingredients comprise the second component, commonly referred to as the “B” component. In any given application, the “B” component may not contain all the above listed components; for example, some formulations omit the flame retardant if flame retardancy is not a required foam property. Accordingly, polyurethane or polyisocyanurate foams are readily prepared by bringing together the A and B side components either by hand mix for small preparations and, preferably, machine mix techniques to form blocks, slabs, laminates, pour-in-place panels and other items, spray applied foams, froths, and the like. Optionally, other ingredients such as fire retardants, colorants, auxiliary blowing agents, water, and even other polyols can be added as a stream to the mix head or reaction site. Most conveniently, however, they are all incorporated into one B component as described above.

A foamable composition suitable for forming a polyurethane or polyisocyanurate foam may be formed by reacting an organic polyisocyanate and the polyol premix composition described above. Any organic polyisocyanate can be employed in polyurethane or polyisocyanurate foam synthesis inclusive of aliphatic and aromatic polyisocyanates. Suitable organic polyisocyanates include aliphatic, cycloaliphatic, araliphatic, aromatic, and heterocyclic isocyanates which are well known in the field of polyurethane chemistry. These are described in, for example, U.S. Pat. Nos. 4,868,224; 3,401,190; 3,454,606; 3,277,138; 3,492,330; 3,001,973; 3,394,164; 3,124.605; and 3,201,372. Preferred as a class are the aromatic polyisocyanates.

Representative organic polyisocyanates correspond to the formula:

R(NCO)z

wherein R is an aliphatic group, an aromatic group, or mixtures thereof, and z is an integer which corresponds to the valence of R and is at least two. Representative of the organic polyisocyanates contemplated herein includes, for example, the aromatic diisocyanates such as 2,4-toluene diisocyanate, 2,6-toluene diisocyanate, mixtures of 2,4- and 2,6-toluene diisocyanate, crude toluene diisocyanate, methylene diphenyl diisocyanate, crude methylene diphenyl diisocyanate and the like; the aromatic triisocyanates such as 4,4′,4″-triphenylmethane triisocyanate, 2,4,6-toluene triisocyanates; the aromatic tetraisocyanates such as 4,4′-dimethyldiphenylmethane-2,2′5,5-′tetraisocyanate, and the like; arylalkyl polyisocyanates such as xylylene diisocyanate; aliphatic polyisocyanate such as hexamethylene-1,6-diisocyanate, lysine diisocyanate methylester and the like; and mixtures thereof Other organic polyisocyanates include polymethylene polyphenylisocyanate, hydrogenated methylene diphenylisocyanate, m-phenylene diisocyanate, naphthylene-1,5-diisocyanate, 1-methoxyphenylene-2,4-diisocyanate, 4,4′-biphenylene diisocyanate, 3,3′-dimethoxy-4,4′-biphenyl diisocyanate, 3,3′-dimethyl-4,4′-biphenyl diisocyanate, and 3,3′-dimethyldiphenylmethane-4,4′-diisocyanate; Typical aliphatic polyisocyanates are alkylene diisocyanates such as trimethylene diisocyanate, tetramethylene diisocyanate, and hexamethylene diisocyanate, isophorene diisocyanate, 4,4′-methylenebis(cyclohexyl isocyanate), and the like; typical aromatic polyisocyanates include m-, and p-phenylene disocyanate, polymethylene polyphenyl isocyanate, 2,4- and 2,6-toluenediisocyanate, dianisidine diisocyanate, bitoylene isocyanate, naphthylene 1,4-diisocyanate, bis(4-isocyanatophenyl)methene, bis(2-methyl-4-isocyanatophenyl)methane, and the like. Preferred polyisocyanates are the polymethylene polyphenyl isocyanates, particularly the mixtures containing 30 to 85 percent by weight of methylenebis(phenyl isocyanate) with the remainder of the mixture comprising the polymethylene polyphenyl polyisocyanates of functionality higher than 2. In certain cases, a so-called isocyanate prepolymer can also be used. The prepolymer is formed by combining an excess of diisocyanate with polyol (polyester polyol, or polyether polyol). These polyisocyanates are prepared by conventional methods known in the art. In the present invention, the polyisocyanate and the polyol are employed in amounts which will yield an NCO/OH stoichiometric ratio in a range of 0.9 to 5.0. In the present invention, the NCO/OH equivalent ratio is, preferably, 0.9 to 4, or 0.95 to 3 Suitable organic polyisocyanates include polymethylene polyphenyl isocyanate, methylene bis(phenyl isocyanate), toluene diisocyanates, or combinations thereof.

In the preparation of polyisocyanurate foams, trimerization catalysts are used for the purpose of converting the blends in conjunction with excess A component to polyisocyanurate-polyurethane foams. The trimerization catalysts employed can be any catalyst known to one skilled in the art, including, but not limited to, glycine salts, tertiary amine trimerization catalysts, quaternary ammonium carboxylates, and alkali metal carboxylic acid salts and mixtures of the various types of catalysts. Preferred species within the classes are potassium acetate, potassium octoate, and N-(2-hydroxy-5-nonylphenol)methyl-N-methylglycinate.

The polyurethane or polyisocyanurate foams produced can vary in density from 0.5 pounds per cubic foot to 60 pounds per cubic foot, or 0.5 to 20.0 pounds per cubic foot, or 0.5 to 15 pounds per cubic foot. The density obtained is a function of how much of the blowing agent or blowing agent mixture plus the amount of auxiliary blowing agent, such as water or other co-blowing agents is present in the A and/or B components, or alternatively added at the time the foam is prepared. These foams can be rigid, flexible, or semi-rigid foams, and can have a closed cell structure, an open cell structure or a mixture of open and closed cells. These foams are used in a variety of well-known applications, including but not limited to thermal insulation, cushioning, flotation, packaging, adhesives, void filling, crafts and decorative, and shock absorption.

The following non-limiting examples serve to illustrate the invention.

### EXAMPLE 1

It is preferred in many embodiments that the selection of the cashew nutshell liquid based polyol of the present invention and the selection of the blowing agent of the present invention needs to be matched such that the selected blowing agent is miscible in the selected cashew nutshell liquid based polyol at a level of at least about 30%, and even more preferably at least about 40% at 110F as measured herein. Applicants have unexpectedly found combinations in which such a level of miscibility is possible, which in turn provides an an unexpectedly level of polyol premix homogeneity, which is an advantage to embodiments that avoid separation of the polyol premix during storage, thus enhancing the stability of the stored polyol premix.

The miscibility of a several cashew nutshell liquid based polyether and Mannich polyols (Polycard™ XFN 50, Polycard™ XFN 53, and Polycard™ XFN 425M available from Chemical Technical Services Inc. of Kettering Ohio) selected by applicants for use with 1233zd(E) has been studied and found to achieve relatively high levels of miscibility. The miscibility of each blend is determined by first blending a 60:40 weight ratio of the selected polyol:1233zd(E) (with a total weight of 70 g) in pressure glass tube. The mixture is thoroughly mixed at an elevated temperature. The tube is then placed in a constant temperature bath at 70 F for 24 hours. If the mixture remains one clear phase, then the miscibility is recorded as being greater than 40% (>40%). If there is a phase separation, the height of the polyol and of 1233zd(E) blowing agent is measured and the amount of the blowing agent remaining in the polyol phase is calculated and reported as the miscibility percentage. The testing is then repeated, except with the tube being place in a constant temperature bath at 110 F for 24 hours. The results are reported in Table 1 below and showed that the selected polyols have good to excellent miscibility with 1233zd(E), which will result in a very low vapor pressure in a formulated system. Polycard™ XFN 50 has a greater than 40% solubility with 1233zd(E) even at room temperature.

TABLE 1

| | | | | 1233zd (E) | |
|---|---|---|---|---|---|
| | | | Biocontent | solubility (%) | |
| Polyol | Category | Functionality | (%) | 70° F. | 110° F. |
| Polycard ™ | Polyether | 4~5 | 95 | >40 | >100 |
| XFN 50 | | | | | |
| Polycard ™ | Polyether | 6~8 | 95 | 32 | 32 |
| XFN 53 | | | | | |
| Polycard ™ | Mannich | 3 | 75 | 16 | >40 |
| XFN 425M | | | | | |

### EXAMPLE 2

Table 2 shows the polyol premix compositions for a control and two cashew nutshell based polyol blends (Polycard™ XFN 50 and Polycard™ XFN 425M) with 1233zd(E) blowing agent and strong tertiary amine catalysts, bis(3-dimethylaminopropyl)-n, n-dimethylpropanediamine (Polycat® 9 available from Air Products and Chemicals Inc.) and pentamethyldiethylene-triamine (Polycat® 5 available from Air Products and Chemicals Inc.).

The control composition contains a blend of a polyester polyol (Terate® 4020 available from Invista of Washington D.C.), a Mannich polyether polyol (Voranol™ 470X available from Dow Chemical Co.), and a sucrose based polyether polyol (Jeffol® SG-360 available from Huntsman International LLC). The XFN 50 composition contains a blend of a polyether cashew nutshell based polyol (Polycard™ XFN 50), a Mannich polyether polyol (Voranol™ 470X), and a sucrose based polyether polyol (Jeffol® SG-360). The XFN 425M composition contained a blend of a Mannich cashew nutshell based polyol (Polycard™ XFN 425M), a polyester polyol (Terate® 4020), and a sucrose based polyether polyol (Jeffol® SG-360).

The polyol premix compositions also contain a silicone surfactant (DC-193 available from Air Products), flame retardants (PHT 4-diol™ LV available from Great Lakes Solutions, a mixed ester of tetrabromophthalic anhydride with diethylene glycol and propylene glycol, and tris (chloroisopropyl) phosphate (TCPP)), water, and a metal catalyst potassium octoate (Dabco® K-15 available from Air Products/Versum Materials).

The polyol premix composition were formed by mixing the various components with a mechanical mixer at 3000 rpm to form a substantially one-phase liquid. The polyol premix compositions were then cooled to 10° C. (50° F.) to minimize the loss of blowing agent. A portion of the polyol premix compositions were used without substantially storage (i.e., within 12 hours of the cooling operation) to form a foam with an initial gel time, another portion was stored for one (1) month at about room temperature and another portion was stored for six (6) months at about room temperature. The stored portions remained as a substantially one-phase liquid after said storage and were then used to form a foam, as described below, and the gel time associated with this stored polyol is determined using substantially the same procedure as was used to determine the gel time of the unstored polyol.

The polyol premix compositions (50 g) were mixed (approximately 5 sec in most cases) with the isocyanate (Lupranate M20 available from BASF), (50 g) (polymeric methylene bis diphenyl diisocyanate (PMDI)) at 21.1° C. (70° F.)) with a mechanical mixer with a mixing speed of 3000 rpm.

The gel times were measured initially, after 1 month aging at room temperature, and after 6 months aging at room temperature. The resultant foamable mixture was poured into an 11″×11″ cardboard box, and the gel time was determined using standard industry techniques. Gel time was determined by repeatedly piercing the top of the foam with a tongue depressor to a depth of about one inch. Gel time is defined as the point when strings of polymer adhere to the tongue depressor upon withdrawal from the foaming mixture. The formulation data and test results are shown in Tables 2 and 3 below.

TABLE 2

| | Control | XFN 50 | XFN 425M |
|---|---|---|---|
| Terate 4020 (polyester polyol) | 60 | | 60 |
| POLYCARD ™ XFN-50 | | 60 | |
| Voranol 470X (Mannich | 30 | 30 | |
| polyol) | | | |
| POLYCARD ™ XFN 425M | | | 30 |
| Jeffol ® SG 360 (Sucrose | 10 | 10 | 10 |
| polyether polyol) | | | |
| Polycat ® 9 (bis(3- | 3 | 3 | 3 |
| dimethylaminopropyl)-n, n- | | | |
| dimethylpropanediamine) | | | |
| Polycat ® 5 | 0.5 | 0.5 | 0.5 |
| (pentamethyldiethylene- | | | |
| triamine) | | | |
| DC193 (silicone surfactant) | 1.5 | 1.5 | 1.5 |
| PHT 4-diol LV (flame | 3 | 3 | 3 |
| retardant) | | | |
| TCPP (tris (chloroisopropyl) | 10 | 10 | 10 |
| phosphate) | | | |
| Water | 2.2 | 2.2 | 2.2 |
| Dabco ® K-15 (potassium | 1 | 1 | 1 |
| octoate) | | | |
| 1233zd (E) (blowing agent) | 12 | 12 | 12 |

TABLE 3

| | Gel Time (s) | | |
|---|---|---|---|
| | Initial | 1 month | 6 months |
| Control | 12 | 14 | 23 |
| XFN 50 | 19 | 20 | 26 |
| XFN 425M | 9 | 12 | 21 |

As can be seen from the results reported above, the reactivity of the control formulation slowed down with aging of the polyol premix, as measured by the substantially increasing gel times for the foams formed from the stored polyols. Without being bound to theory, applicants believe this degredation in reaction rates is due to reaction(s) occurring between 1233zd (E) and tertiary amines (Polycat® 9 and Polycat® 5). The gel time for the control formulation (without biobased polyol) increased about 16% (from 12 sec to 14 sec) after one month room temperature aging, and increased almost 100% (from 12 sec to 23 sec) after 6 month aging. Under the same aging conditions, the reactivity change was much smaller when Polycard™ XFN 50 was used in the polyol blend, only 5% (19 sec to 20 sec) for 1 month aging and 37% (19 sec to 26 sec) after 6 month aging. The Mannich type bio-based polyol, Polycard XFN 425M, however, did not provide any improvement on the stability of the polyol blend (9 sec to 12 sec at 1 month and 21 sec at 6 months).

### EXAMPLE 3

In this example, the Polycat® 9 tertiary amine catalyst was substituted with the tertiary amine catalyst triethylenediamine (Dabco® 33LV available from Air Products). Table 4 shows the polyol premix compositions.

TABLE 4

| | Control | XFN 53 | XFN 425M |
|---|---|---|---|
| Terate 4020 (polyester polyol) | 60 | | 60 |
| POLYCARD ™ XFN-50 | | 70 | |
| Voranol 470X (Mannich | 30 | 30 | |
| polyol) | | | |
| POLYCARD ™ XFN 425M | | | 30 |
| Jeffol ® SG 360 (Sucrose | 10 | | 10 |
| polyether polyol) | | | |
| Dabco ® 33LV | 3 | 3 | 3 |
| (triethylenediamine) | | | |
| Polycat ® 5 | 0.5 | 0.5 | 0.5 |
| (pentamethyldiethylene- | | | |
| triamine) | | | |
| DC193 (surfactant) | 1.5 | 1.5 | 1.5 |
| PHT 4-diol LV (flame | 3 | 3 | 3 |
| retardant) | | | |
| TCPP (tris (chloroisopropyl) | 10 | 10 | 10 |
| phosphate) | | | |
| Water | 2.2 | 2.2 | 2.2 |
| Dabco ® K-15 (potassium | 1 | 1 | 1 |
| octoate) | | | |
| 1233zd (E) (blowing agent) | 12 | 12 | 12 |

The control polyol premix had an initial gel time of 12 sec, 35 sec at 1 month, and 54 sec at 6 months, which is believed to be, without being bound by theory, due to strong reaction between Dabco 33LV and 1233zd(E). The XFN 50 polyol premix as initially formed was a substantially one-phase liquid and remained as a substantially one-phase system after each of said storage periods. The XFN 50 polyol premix showed short term stabilization (22 sec initially and 22 sec at 1 month). At 6 months the gel time had increased to 45 sec. The XFN 425M polyol premix had an initial gel time of 12 sec, 22 sec at 1 month, and 37 sec at 6 months.

### EXAMPLE 4

Table 5 shows an example of a polyol premix with especially enhanced long term stability. The polyol premix contained a blend of the polyether cashew nutshell based polyol (Polycard™ XFN 50) the Mannich cashew nutshell based polyol (Polycard™ XFN 425M), and the sucrose based polyether polyol (Jeffol® SG-360).

The polyol premix (50 g) was mixed with an isocyanate (Lupranate® M20S available from BASF) (50 g) at 21.1° C. (70° F.)) with a mechanical mixer with a mixing speed of 3000 rpm.

The polyol premix composition as initially formed was a substantially one-phase liquid and remained as a substantially one-phase system after each of said storage periods mentioned below.

The cream time, gel time, and tack free time were measured initially, and after 1 month, 3 months, and 6 months. The gel time was determined as described above. The cream time is a measure of the beginning of the foam reaction between isocyanates and polyols. It is usually characterized by a change in the color of the mixture as it begins to rise.

That is, it is measured from the mixing of all foam forming components until the mixture begins to change color from a darker tan/brown to a light cream indicating the presence of bubbles forming in the foaming mass. The tack free time is the time at which the top of the foam can be touched with a tongue depressor or a gloved hand, and no polymer is pulled of when the tongue depressor or gloved hand is removed.

The formulation shows long term stability. The gel time only increased from 17 sec initially to 19 sec with 6 months aging.

TABLE 5

| Polyol component | phpp* | | | |
|---|---|---|---|---|
| POLYCARD ™ XFN-50 | 60 | | | |
| POLYCARD ™ XFN | 30 | | | |
| 425M | | | | |
| Jeffol ® SG 360 (Sucrose | 10 | | | |
| polyether polyol) | | | | |
| Polycat ® 9 (bis(3- | 1.5 | | | |
| dimethylaminopropyl)-n, | | | | |
| n-dimethylpropane- | | | | |
| diamine) | | | | |
| Polycat ® 5 | 0.5 | | | |
| (pentamethyldiethylene- | | | | |
| triamine) | | | | |
| DC193 (surfactant) | 1.5 | | | |
| PHT 4-diol LV (flame | 3 | | | |
| retardant) | | | | |
| TCPP (tris | 10 | | | |
| (chloroisopropyl) | | | | |
| phosphate) | | | | |
| Water | 2.2 | | | |
| K-15 (potassium octoate) | 1 | | | |
| 1233zd (E) (blowing | 12 | | | |
| agent) | | | | |
| Lupranate ® M20S | 107 index** | | | |
| (isocyanate) | | | | |
| Reactivity | | Aging time (RT, month) | | |
| | Initial | 1 | 3 | 6 |
| Cream time (s) | 8 | 8 | 10 | 9 |
| Gel time (s) | 17 | 17 | 19 | 19 |
| Tack free time (s) | 24 | 25 | 26 | 23 |

*parts per hundred parts of polyol
**Index is the ratio of chemical equivalents of isocyanate to equivalents of isocyanate-reactive groups times 100.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A storage stable polyol premix composition that has been stored for a period of at least 1 month comprising:
polyol component comprising at least 10 wt % of a cashew nutshell liquid based polyol based on a total weight of the polyol component;
tertiary amine catalyst;
silicone surfactant; and
blowing agent comprising a hydrohaloolefin and optionally a fluorocarbon, chlorocarbon, chlorofluorocarbon, hydrocarbon, ether, ester, aldehyde, ketone, acetal, organic acid, atmospheric gas, water, gas generating materials, or combinations thereof,
wherein (i) said stored polyol premix composition is a single liquid phase after being stored for 1 month and (ii) foam formed from said polyol premix which has been aged at room temperature for at least 1 month has a gel time less than 50% greater than an initial gel time.

2. The polyol premix composition of claim 1 where the cashew nutshell liquid based polyol is selected from the group consisting of cashew nutshell liquid based polyether polyol, cashew nutshell liquid based polyester polyol, cashew nutshell liquid based Mannich polyol, and combinations of two or more of these.

3. The polyol premix composition of claim 1 wherein the polyol component further comprises an additional polyol.

4. The polyol premix composition of claim 3 wherein the additional polyol comprises sucrose containing polyol.

5. The polyol premix composition of claim 4 wherein the polyol component consists essentially of said cashew nutshell liquid based polyol and said sucrose containing polyol.

6. The polyol premix composition of claim 4 wherein the cashew nutshell liquid based polyol is present in an amount of from about 20 wt % to about 99 wt % of the total weight of the polyol component and the additional polyol is present in an amount of from about 1 wt % to about 80 wt % based on the total weight of the polyol component.

7. The polyol premix composition of claim 1 wherein the hydrohaloolefin comprises are 1,3,3,3-tetrafluoropropene; 2,3,3,3-tetrafluoropropene; 1,1,3,3-tetrafluoropropene; 1,1,1,3-tetrafluoropropene; 1,1,1,2-tetrafluoropropene; 1,2,3,3,3-pentafluoropropene; 1,1,1-trifluoropropene; 3,3,3-trifluoropropene; 1,1,1,3,3-pentafluoropropene; 1,1,1,3,3,3-hexafluorobut-2-ene, 1,1,2,3,3-pentafluoropropene; 1,1,1,2,3-pentafluoropropene; 1-chloro-3,3,3-trifluoropropene; 2-chloro-3,3,3-trifluoropropene (HFO-1233 xf); 1,1,1,4,4,4-hexafluorobut-2-ene, cis-1,1,1,4,4,4,-hexafluoro-2-butene; or combinations thereof; and structural isomers, geometric isomers, or stereoisomers thereof; or combinations thereof.

8. The polyol premix composition of claim 1 wherein the hydrohaloolefin comprises trans-1,3,3,3-tetrafluoropropene, trans-1-chloro-3,3,3-trifluoropropene, cis-1,1,1,4,4,4-hexafluorobut-2-ene, or stereoisomers thereof, or combinations thereof.

9. The polyol premix composition of claim 1, wherein the polyol premix aged at room temperature for about 1 month has a gel time less than 25% greater than the initial gel time.

10. The polyol premix composition of claim 9, wherein the polyol premix aged at room temperature for at least 6 months has a gel time less than 100% greater than the initial gel time.

11. The polyol premix composition of claim 10, wherein the polyol premix aged at room temperature for at least 6 months has a gel time less than 50% greater than the initial gel time.

12. A method of forming a foam comprising:
(a) providing a storage stable polyol premix composition comprising:
(i) polyol component comprising at least 10 wt % of a cashew nutshell liquid based polyol based on a total weight of the polyol component;
(ii) tertiary amine catalyst;
(iii) silicone surfactant; and
(iv blowing agent comprising a hydrohaloolefin and optionally a fluorocarbon, chlorocarbon, chlorofluorocarbon, hydrocarbon, ether, ester, aldehyde, ketone, acetal, organic acid, atmospheric gas, water, gas generating materials, or combinations thereof,
(b) storing said polyol premix composition for at least about 1 month, wherein said stored polyol premix composition is a single liquid phase after said storage period; and
(c) forming a foam using said stored polyol premix composition, wherein said foam formed from said stored polyol premix has a gel time less than 50% greater than an initial gel time.

13. The method of claim 12 wherein said step (b) of storing said polyol premix composition comprises storing said polyol premix composition for at least about 3 months and wherein said stored polyol premix composition is a single liquid phase after said storage period.

14. The method of claim 13 wherein said step (b) of storing said polyol premix composition comprises storing said polyol premix composition for at least about 6 months and wherein said stored polyol premix composition is a single liquid phase after said storage period.

15. A foam formed according to the method of claim 12.

16. The method of claim 12 wherein said hydrohaloolefin is selected from the group consisting of trans-1,3,3,3-tetrafluoropropene, trans-1-chloro-3,3,3-trifluoropropene, cis-1,1,1,4,4,4-hexafluorobut-2-ene and combinations of two or more of these.

17. The method of claim 12 wherein said foam formed from said stored polyol premix has a gel time less than 25% greater than the initial gel time.

18. The method of claim 12 wherein said storage step comprises storing said polyol premix composition for at least about 3 months and wherein foam formed from said stored polyol premix has a gel time less than 50% greater than the initial gel time.

19. The method of claim 12 wherein said storage step comprises storing said polyol premix composition for at least about 6 months and wherein foam formed from said stored polyol premix has a gel time less than 100% greater than the initial gel time.

20. A foam produced according to the method of claim 18.
